(19) United States
(12) Patent Application Publication
(10) Pub. No.: US 2016/0240879 A1
(43) Pub. Date: Aug. 18, 2016

(54) CATIONIC SUPPORT FORMING A HYBRID ANIONIC MEMBRANE

(71) Applicant: CENTRE NATIONAL DE LA RECHERCHE SCIENTIFIQUE (C.N.R.S.), Paris (FR)

(72) Inventors: Bernard GAUTHIER-MANUEL, BESANCON (FR); Jamal EL MANSOURI EL MOUDEN, BESANCON (FR)

(21) Appl. No.: 15/025,178

(22) PCT Filed: Sep. 25, 2014
(86) PCT No.: PCT/EP2014/070564

§ 371 Date: Mar. 25, 2016

(30) Foreign Application Priority Data
Sep. 27, 2013 (FR) 13 59366

(51) Int. Cl. H01M 8/106; H01M 8/1037; H01M 8/1072

(52) U.S. Cl. CPC H01M 8/106; H01M 8/1074; H01M 8/1037

(57) ABSTRACT

The present invention relates to a cationic support notably forming a hybrid anionic membrane. The present invention notably relates to a cationic support comprising a solid inorganic support comprising pores, said pores comprising at least at the surface, bound through a covalent bond to the inorganic support, a silica gel comprising cationic groups, designated here as “cationic silica gel” or “cationic silica sol”. More particularly, the present invention relates to an anionic membrane for a fuel cell, in particular of the PEM (“polymer exchange membrane”) type.

### FIELD OF THE INVENTION

The present invention relates to a cationic support notably forming a hybrid anionic membrane. More particularly, the present invention relates to an anionic membrane for a fuel cell, notably of the PEM (Polymer Exchange Membrane) type.

### BACKGROUND OF THE INVENTION

One of the essential components of good operation of a fuel cell of the PEM type is the membrane conducting the ions inside the cell. Traditionally these cells operate in a cationic mode and this function is ensured by an expensive ionomer proton conductor such as Nafion®. However, this poses the technical problem of imposing operation under cationic conditions. Moreover this also requires to operate with platinum as a catalyst. These technical problems are an obstacle to the development of these devices. Indeed, platinum is a rare and expensive metal which for example should be replaced with other metals less expensive such as nickel, etc. Such metals are presently used in great power stationary installations operating at a high temperature for working under anionic conditions and thereby replacing platinum. However, these methods impose working at a high temperature and therefore membranes should be available allowing operation at room temperature. This should open the door to miniature anionic fuel cells.

Among the solutions envisioned over these recent years, mention may be made of polymers bearing quaternary ammonium functions but which have the drawback of being fragile and unstable notably because of the swelling induced by inherent hydration upon its use.

### SUMMARY OF THE INVENTION

The object of the present invention is to solve the technical problems mentioned above.

More particularly, the object of the present invention is to provide an anionic membrane which may operate at room temperature in a fuel cell. The object of the present invention is also to provide an anionic membrane with which platinum may be replaced with other metals in particular less expensive, such as nickel in a fuel cell. The object of the present invention is also to provide an anionic membrane which is stable in an alkaline medium.

Thus, the object of the present invention is to provide a less expensive membrane, stable and for which the conductometric performances are close to those of standard proton membranes used in fuel cells. More particularly, the object of the invention is to provide a membrane used in devices or methods for generating hydrogen and/or oxygen by electrolysis of water.

The object of the present invention is further to provide a membrane which may be used in a biologically compatible device notably for being implanted in a human or animal body.

The present invention according to a first aspect relates to a cationic support comprising a solid inorganic support comprising pores, said pores comprising at least at the surface, bound through a covalent bond to the inorganic support a silica gel comprising cationic groups here designated as “cationic silica gel” or “cationic silica sol”.

Advantageously, the solid inorganic support comprising pores is porous silicon, porous silicon carbide, porous alumina or a porous glass.

According to a preferred embodiment, the cationic groups are quaternary ammonium groups.

According to an advantageous alternative, the cationic groups, and in particular the quaternary ammoniums, are bound to the silica gel through at least one saturated, linear or branched, optionally substituted alkyl group.

According to an embodiment, the pores are in totality or partly filled with the cationic silica gel.

An alkyl group is selected from among a methyl, ethyl, propyl, butyl group.

Advantageously, the inorganic support of the present invention is a porous silicon.

Advantageously, the inorganic support is a semi-conductor.

### BRIEF DESCRIPTION OF THE DRAWINGS

FIG. 1 schematically illustrates a sectional view of a fuel cell according to an embodiment of the invention. The cell consists of a stack of three silicon wafers (a, b, c). The central wafer (a) bears the anionic membrane (10). On the active surface of each face of the central wafer (a) is deposited an anionic catalytic ink. The lower wafer (b) consists of hydrogenated porous silicon (20). The upper wafer (c) consisting of macroporous silicon permeable to oxygen contains a <<water reservoir (30)>>. A film impervious to carbon dioxide (for example PTFE) (50) isolates the cell from any external contamination.

FIG. 2 illustrates a schematic view of a mask for preparing membranes according to the invention.

### DETAILED DESCRIPTION OF CERTAIN EMBODIMENTS OF THE INVENTION

A semi-conductor used as a solid support gives the possibility of controlling the porosity percentage and the dimensions of the pores. The gas-impervious electrochemically inert microporous matrix and to a certain extent impervious to certain liquids, provides the mechanical strength properties and forms a barrier to the diffusion of fuel molecules, notably for anionic membrane applications, in particular in fuel cells. Further, the use of a semi-conductor provides quality surfaces for the treatment with deposition electrodes.

The use of a semi-conductor also allows the application of methods resorting to microtechnologies for the machining and deposition of metal layers and to the standard “bounding” techniques. The microtechnologies give the possibility of achieving multilayer metal depositions with an optimized thickness. It is thus possible to integrate electronic circuits for managing energy. The collective microfabrication potential from slices or “wafers” in semi-conducting materials allows application of a limited number of operations, compatible with low production costs.

The semi-conductor is preferably silicon. It is advantageously used in the form of slices (wafers) with standard dimensions, such as 4 inches (10.16 cm), 6 inches (15.24 cm) or 8 inches (20.32 cm). The thickness will generally range from 200 to 800 μm. The semi-conductor is preferably oxidized at least at the surface in order to make it an electric insulator on predetermined areas. The silicon substrate is generally a silicon plate. This substrate contains preferably at most atomic 10¹⁹ cm⁻³ of impurities such as boron or phosphorus, for example. The porous silicon substrate preferentially used in the present invention is for example a standard substrate of microelectronics, such as silicon doped with phosphorus, with a resistivity typically of the order of 0.012 Ω·cm to 0.016 Ω·cm, or silicon doped with boron, with a resistivity for example of the order of 0.005 Ω·cm.

The porous support forming an anionic membrane is advantageously made by etching an inorganic support. According to an embodiment, the porous support forming an anionic membrane is advantageously made by etching a semi-conductor, for example the aforementioned ones.

For the porous support forming an anionic membrane, embodiments are preferred which consist of making the silicon porous by electrochemical anodization. The support has a significant specific surface area and a high surface roughness. According to the method used for making the porous support, it is possible to deposit on silicon a layer of silicon dioxide, which is an electric insulator. The thickness of the support may be less than the usual thickness of 100 μm for fuel cell membranes and may thus be for example of about 40 μm. A limit of the thickness is the mechanical stiffness of the membrane. The porous inorganic support forming an anionic membrane for example has a thickness comprised between 10 and 500 μm, and preferably between 20 and 100 μm, and further preferably between 30 and 50 μm.

The diameter of the channels and the porosity of the support are defined by the anodization conditions and may be set according to the parameters of the method.

For producing an ionic membrane for a fuel cell, it is necessary that the membrane has a sufficient amount of pores crossing along the thickness of the membrane in order to allow an ion conductivity (hydroxide ions). This result may be validated after preparation of the membrane by checking its ion conductivity.

According to a preferred embodiment, the porous silicon used consist of mesoporous silicon, i.e. including pores with a size comprised between 2 and 50 nm (mesopores) and/or microporous, i.e. including pores with a size of less than 2 nm (micropores).

The presence of the pores (notably mesopores and/or micropores) gives the possibility inter alia, of increasing the specific surface area of the silicon substrate. The porosity of the silicon is comprised between about 10% and about 70% by volume. The specific surface area of the silicon is comprised between about 200 and about 900 m²·cm⁻³. This specific surface area may for example be determined by the BET method when the silicon is in a sufficient amount. The aforementioned BET method is the BRUNAUER-TELLER method notably described in The Journal of the American Chemical Society, Volume 60, page 309, February 1938 and corresponding to the international standard ISO 5794/1. The specific surface area of a silicon may for generally be determined by quantification of the mass of a self-assembled silane monolayer on the surface of the porous silicon to be characterized.

The porous silicon may be obtained by electrochemical treatment of a silicon substrate with an acid, this acid being advantageously hydrofluoric acid.

In an embodiment, the electrochemical treatment is an electrochemical anodization which is preferably carried on a single crystal, polycrystalline or amorphous silicon substrate. After electrochemical treatment, the silicon substrate has become both mesoporous and/or microporous.

The obtained porous silicon generally includes nano-crystallites and/or nano-particles of silicon of various geometrical shapes, interconnected or not between each other, at least one dimension of which is less than or equal to about 100 nm and the sum of the surfaces of each crystallite and/or nano-particle is greater than the planar surface area occupied by silicon.

The diameters of the pores of the solid inorganic silicon support are preferably comprised between 5 and 40 nm (this diameter is understood of the pores of the inorganic support before binding to the silica gel). The diameter of the pores is measured by Scanning Electron Microscopy (SEM) on a section of the material obtained by cleaving. This is the diameter of the pores as observed in an SEM.

The fact that the silicon is strongly doped allows direct measurement without any preliminary metallization of the sample by using a field effect SEM.

More particularly, the inorganic support is prepared according to methods known from the state of the art. It may be obtained by anodization of a silicon support in a hydrofluoric acid medium, generally in the presence of ethanol or a surfactant. For example, the porous silicon support may be prepared from a silicon for which the surface is oxidized, for example by heat oxidation in a oxidizing medium, and then photolithography is performed by means of a mask in order to strip under stripping conditions only the portions exposed to the stripping conditions, such as for example chemical stripping with BHF in an alkaline medium, pores are then generated in the surface layer of silicon dioxide by anodization. The pores may be made hydrophilic by standard treatments. Reference may be made for example to the description of the international application WO 2004/091026 or to the article of Tristan Pichonat, Bernard Gauthier-Manuel, Realization of thick mesoporous silicon membranes: application to miniature fuel cells, Journal of Membrane Science 280 (2006) 494, both incorporated herein by reference. Next, takes place the coupling with the silica gel and the growth of the silica gel grafted on the surface of the pores of the porous support.

According to an alternative, the porous silicon is prepared from the hydrogenated porous silicon support described in the international patent application WO 2008/148988, for which the surface of the pores is coupled with the silica gel. Optionally the surface of the pores of the hydrogenated porous silicon support is oxidized and hydroxylated before coupling with the silica gel.

An inorganic support not having at the surface any Si—H or Si—OH functions may be activated (for the grafting according to the invention) by a step for activating the surface in order to generate OH functions available for grafting by a sol-silica gel. Such an activation step may be carried out for example by activating the surface of the inorganic support by a UV-ozone treatment as this is for example described according to the invention for the porous silicon membranes. The support may then be used for grafting the sol-silica gel. Such a procedure may be applied on an inorganic support comprising or consisting of porous glass, for example.

According to an alternative, the volume porosity is preferably comprised between 40 and 60% based on the initial volume of the porous inorganic support.

The volume porosity corresponds to the ratio between the volume of the pores present in the sample and the volume of the sample. This porosity is determined, for example by calculating the refractive index of the porous silicon from an optical reflectometry measurement, or else by weighing by comparing the masses of the sample before and after anodization.

The inorganic support may have an outer macroscopic surface of 10 mm² (surface of the sample excluding the surface of the pores).

The cationic support advantageously has, after coupling and grafting of silica gel, the following features:

A dimensional stability, ensured by the inorganic backbone, independent of the hydration level of the gel contained in the pores. An ion conductivity generally greater than 5 mS/cm, preferably greater than 8 mS/cm, and further preferably greater than 10 mS/cm. The ion conductivity is for example measured by impedance spectrometry in a water-saturated atmosphere (RH>98%) after deposition of a gold layer with a thickness of 20 nm by cathode sputtering on each face of the membrane.

Advantageously, the concentration of cationic groups is comprised between 0.5 and 10 mol/l of cationic groups. This concentration is for example measured specifically by transmission infrared spectrometry by utilizing the optical transparency of the doped porous silicon in this range of frequencies. Specific quantification results from the prior calibration of the area of the frequency band associated with a covalent bond characteristic of the cationic group, for example that of the characteristic doublet of N—CH₃ bonds at 1,481 and 1,492 cm⁻¹ for the quaternary ammonium groups, by using the reagents in solution in a solvent, for example methanol, at a known concentration and placed in a liquid cell, the thickness of which is specifically measured simultaneously by interferometry. This concentration is added to the actual concentration of silica gel by taking into account the volume of the porosity of the sample.

According to a second aspect, the present invention relates to a method for preparing a cationic support according to the present invention, said method comprising a coupling reaction through a covalent bond (or grafting) between the surface of pores of a porous solid inorganic support, made reactive beforehand, and a silane or a mixture of silane comprising at least one cationic group and at least one reactive group with the reactive surface of the inorganic support, and the obtaining of a solid inorganic support for which the pores comprise at least at the surface a silica gel comprising cationic groups, designated here as “cationic silica gel” or “cationic silica sol”.

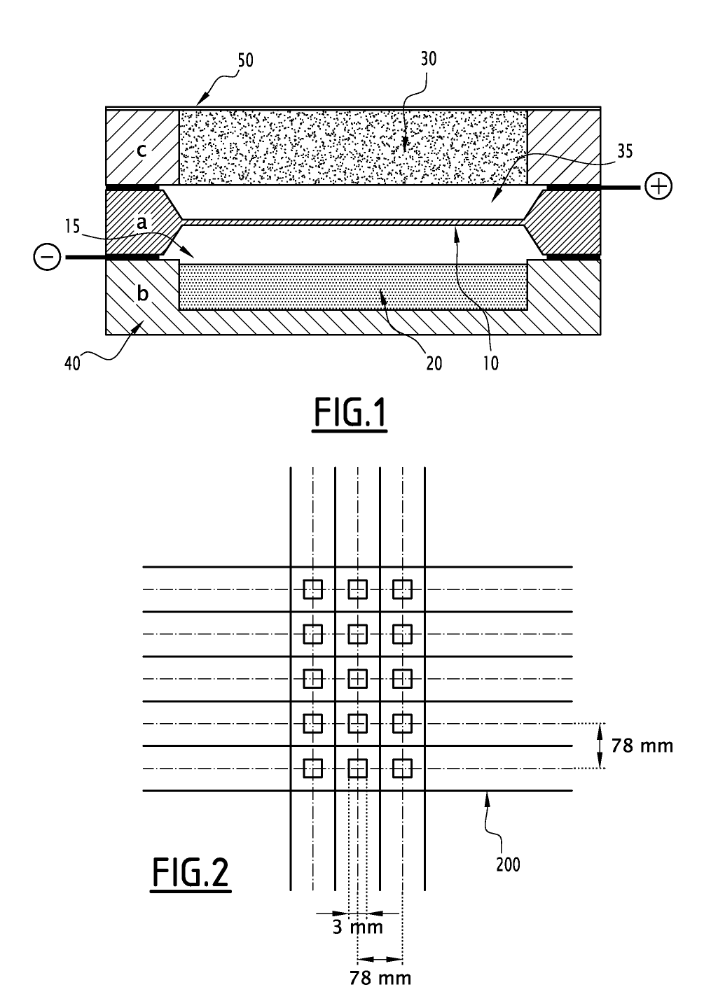

A silane may be illustrated according to the present invention by the general formula SimH2m+2, wherein at least one hydrogen atom is replaced with a reactive group with the inorganic support, such as a halogen or alkoxy group, and at least one other hydrogen atom is replaced with a substituent bearing a cationic group, m represents the number of silicon atoms in the silane. According to a preferred alternative, m represents the FIG. 1.

Advantageously, the substituent comprises a spacer group between the silicon atom and the cationic group. According to an alternative, a spacer group is an alkyl group optionally comprising one or several heteroatoms, for example selected from O, N, and S, and/or optionally comprising one or several aromatic groups.

One or several of the hydrogen atoms present in the spacer group may for example be replaced with a halogen atom, and preferably with a fluorine atom. The spacer group may notably comprise a group —CF₂—

According to a particular embodiment, at least one of R1, R2, R3 is an alkyl group, according to an alternative R1=R2=R3.

Advantageously, the silane is a N-dialkoxysilylalkyl or N-trialkoxysilylalkyl-N,N,N-tri-alkoxyammonium of formula (I):

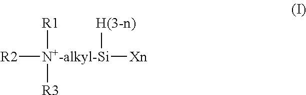

wherein n represents the FIG. 1, 2 or 3, <<alkyl>> is a linear or branched saturated alkyl group, optionally substituted, R1, R2 and R3 are substituents of the nitrogen atom, either identical or different, X is a reactive group with a Si—OH group.

Preferably, n represents the FIG. 2 or 3 (difunctional or trifunctional silane).

For example, a reactive group X with a Si—OH or Al—OH group is a hydroxy or alkoxy group. From among alkoxy groups, mention may notably be made of C₁-C₄ alkoxy groups and more particularly methoxy, ethoxy, and propoxy groups. It is possible to contemplate the use of chlorosilanes (CI group) but the conditions are more difficult to control notably as regards controlling hygrometry.

According to an alternative, the group X is a methoxy group.

Advantageously, the silane bears two or three reactive groups X.

Advantageously, the presence of at least one portion of the silane mixture includes 3 reactive groups X so as to allow three-dimensional growth of the graft.

Preferably, in formula (I) the substituents R1, R2 and R3 are selected from among a C₁-C₄ alkyl or a chorine atom.

It is advantageously possible to use a silane selected from among: dimethyloctadecyl[3-(trimethoxysilyl)propyl]ammonium chloride (CAS 27668-52-6); N,N-didecyl-N-methyl-N-(3-trimethoxysilylpropyl)ammonium chloride (CAS 68959-20-6); 3-(N-Styrylmethyl-2-aminoethylamino)-propyltrimethoxysilane hydrochloride (CAS 34937-00-3); tetradecyldimethyl(3-trimethoxysilylpropyl)ammonium chloride (CAS 41591-87-1).

Preferably, N-trimethoxysilylpropyl-N,N,N-trimethylammonium chloride (CAS 35141-36-7) is used as a reactive silane for grafting cationic groups on the porous inorganic support.

According to a first alternative, the support is a porous silicon, and said method comprises oxidation of the porous silicon (Si—H) at the surface of the pores in order to obtain a (Si—O—Si) function, and hydroxylation of the silicon obtained at the surface of the pores for obtaining (Si—OH) functions, prior to the coupling reaction.

The surface of the pores of the inorganic support is more or less oxidized depending on the history of the relevant surface, and notably depending on the storage conditions, the rinsing method and oxidation conditions.

Typically, the oxidation conditions are the following:

The hydrogenated porous silicon is for example immersed in a solution of 35% nitric acid for 4 minutes. The oxidation by a piranha mixture or by concentrated nitric acid proves to be too powerful and the constraints caused by the thickness of the oxide layer leads to destruction of the membranes.

An oxidation procedure is for example described in application WO 2004/091026.

Typically, the hydroxylation conditions (obtaining Si—OH functions) may be the following:

The porous silicon is immersed in an acid aqueous solution at pH 4 at 80° C. for several minutes or hours, typically 30 minutes.

The porous silicon may advantageously be placed in the presence of ozone, for example obtained from the oxygen with illumination by ultraviolet light (28 mW/cm², 30 minutes on each face) directly generating hydroxy functions.

The Si—OH functions are particularly suitable for coupling through a covalent bond with a silane molecule bearing reactive groups. These conditions should give the possibility of avoiding the presence of Si—H or O—Si—H residual functions which may cause dissolution of the silicon into a basic medium. It is possible to check by infrared spectroscopy that the relevant Si—H functions are actually oxidized. The absence of Si—H or O—Si—H bonds at the surface allows stabilization of the inorganic support in an alkaline medium.

Activation (oxidation) is carried out beforehand on the porous support: The hydroxylated porous silicon (surface bearing hydrophilic Si—OH functions and therefore covered with a film of water) is first of all oxidized, for example by heating for example to 120° C. for several minutes in an oven in order to generate non-hydrated Si—OH functions and therefore reactive functions. Typically, the grafting conditions are the following: The grafting reaction takes place for example by immersion of the porous support in a solution of silane in an alcohol, such as for example methanol under alkaline conditions (pH 8-10 for example). The mass concentration of silane in the alcohol, preferably methanol, is comprised between 20 and 70%, and preferably is of about 50%. Typically, the silane bearing the cationic functions (quaternary ammonium for example) hydrolyzed beforehand by action of water at room temperature and added with one 1M potassium chloride for screening the electric charges is introduced into at least one portion of the porous volume and the reaction is left to continue for several hours at pH 9. Next the samples may be rinsed and then ovened for example at 120° C. for several minutes. The K+ and Cl⁻ ions from the potassium chloride may then be removed, for example by immersions in water containing ion exchange resins.

According to a second alternative, the support is porous silicon, and the coupling between the surface of the pores of the porous solid inorganic support and the silane or mixture of silane is carried out by reaction between the surface of pores of the porous solid inorganic support including Si—H functions and a silane bearing one or several alkoxy groups, and preferably methoxy.

This alternative advantageously gives the possibility of avoiding the hydroxylation and activation (oxidation) steps of the first alternative described above. Advantageously, coupling (grafting) of a first monolayer of silica gel is carried out by immersion of the porous support in a diluted solution of silane in an alcohol, preferably methanol. The mass concentration of silane in the methanol for example varies from 0.1 to 10%. The silane concentration in the methanol is typically 5%. The grafting is preferably carried out under an inert gas. These conditions give the possibility of thereby reacting a silane or mixture of silanes bearing one or several alkoxy groups, preferably methoxy. The support is then placed under hydrolyzing conditions for hydrolyzing the grafted silane molecules. For example, the support may be immersed into a hydrolyzing solution, for example an acid solution with a pH of about 3-5, typically pH 4, this may be a hydrochloric acid solution. The growth of the silica gel then takes place. For example, the growth is achieved by immersion of the support in a silane solution in an alcohol, preferably methanol, under acid conditions. Typically this growth is achieved by immersion of the support in a silane solution in methanol which is more concentrated than in the step for grafting the monolayer. The mass concentration of silane in methanol for example varies from 1 to 20%. Next the samples may be rinsed and then ovened for example at 120° C. for several minutes.

Infrared spectroscopy gives the possibility of easily characterizing all the steps (oxidation, hydroxylation, grafting) with a sensitivity of less than the grafted molecular monolayer.

Advantageously, the use of a tri-functional silane gives the possibility of building a three-dimensional multilayer structure grafted inside pores of the porous support, and more particularly of obtaining a larger volume in which cationic groups are present.

Advantageously, the coupling reaction is carried out according to a sol-gel method, notably for obtaining a silica gel.

The invention further relates to a cationic support as prepared according to the method of the invention.

According to a third aspect, the present invention relates to an anionic membrane consisting of or comprising a cationic support according to the present invention. The cationic support of the invention may be used in an alkaline medium, which allows it to be used as an anionic membrane of hydroxide ions.

According to a fourth aspect, the present invention relates to a device comprising an anionic membrane as defined according to the present invention.

The membrane of the invention may be integrated into a bipolar or unipolar architecture. The cell according to the invention is notably adapted to the power supply of portable electronic devices.

Advantageously, the device is a fuel cell comprising a membrane (10) comprising or consisting of an inorganic support as defined according to the invention.

Methods for preparing fuel cells are described in the prior art and may be applied by analogy. Reference may notably be made to the application WO 2004/091026 incorporated herein by reference.

Present microcells consist of a stack of membranes and electrodes which are compressed in order to guarantee the seal.

The microcells according to the invention may be manufactured in series according to automated means of the semi-conductor industry. The size and the geometrical arrangement of the cells may be easily adapted.

From among fuel cells, mention may notably be made of hydrogenated water-silicon fuel cells.

A hydrogenated silicon is described in the international patent application published under the number WO 2008/148988, French patent application FR 2 915 742 and American patent application U.S. Ser. No. 12/598,745, which are incorporated by reference herein.

According to an alternative, the hydrogenated silicon is milled and optionally compacted.

After the electrochemical treatment, all or part of the surface of the silicon substrate, notably of the porous silicon substrate, includes silicon groups bound to hydrogen atoms, surface —Si—H groups, able to apply the reaction (III) for producing hydrogen as mentioned hereafter.

According to an embodiment, the device for providing dihydrogen of the fuel cell includes a system for loading hydrogenated silicon. This system allows initial introduction of the hydrogenated silicon. Moreover, additional hydrogenated silicon may be reintroduced into the device for providing hydrogen from the cell via this loading system, when the initially present silicon substrate is entirely consumed or else when it is consumed beyond a certain threshold, for example beyond 75%, or even 85%, even better 95% of the initially present porous hydrogenated silicon. The system for loading hydrogenated silicon may be an external loading system or a system allowing exchange of a cartridge containing the hydrogenated silicon. The hydrogenated silicon is typically contained in a removable container, for example a cartridge which may be hermetically snapped-on to the fuel cell.

A fuel cell according to the present invention may advantageously have:
a cathode portion comprising a cathode;
an anode portion comprising an anode;
one or several devices for putting a water source and/or an oxygen source in contact with the cathode portion;
a hydrogenated porous silicon in contact with the anode portion;
said cathode portion and anode portion being physically separated by an anionic membrane according to the present invention.

During operation, the cathode portion applies the reaction (I):

O₂+2H₂O+4e⁻→4OH⁻ (I)
the anode portion applies the reaction (II)

2H₂+4OH⁻→4H₂O+4e⁻ (II), and
the water in contact with the hydrogenated porous silicon gives the possibility of applying the reaction (III) producing hydrogen:

Si—Si—H+4OH⁻→2H₂+Si—H+Si(OH)₄ (III)

The hydroxide ions OH⁻ are transferred from the cathode to the anode through the anionic membrane according to the present invention.

The alkaline solution used in the method of the invention is preferably an aqueous alkaline solution. The pH of the alkaline solution is notably comprised between 8 and about 14, preferably between about 9 and 13, for example of the order of 10. The base may notably be selected from NaOH, KOH, and NH₄OH. Preferably, the aqueous alkaline solution is an aqueous solution of NaOH and/or KOH.

The invention therefore relates to a method for producing dihydrogen, for example from water and oxygen.

According to the invention, the reaction temperature on the hydrogenated silicon is generally comprised between about 10° C. and about 40° C., preferably this temperature is conducted at room temperature. The reaction preferably takes place at atmospheric pressure or at slightly higher pressures, generally less than or equal to about 2 bars, comprised between about 1 bar and 1.5 bars.

An advantage of the use of the aforementioned reaction is to allow production of dihydrogen in a single step.

Another advantage is to allow regulation of the amount of water provided for the reaction with the hydrogenated porous silicon. Controlling the electric current allows regulation of the provision of dihydrogen.

According to an embodiment, the fuel cell further comprises a system for loading water at the cathode portion. This loading system gives the possibility of initially introducing water, and of regenerating it during the life of the cell, notably for replenishing it with water. The water loading system allowing operation of the cell may notably be external. The device may operate continuously.

According to a particularly advantageous alternative, the water is provided by the ambient atmosphere. Thus the source of water gives the possibility of putting the humidity contained in the atmosphere in contact with the cathode for applying the reaction (I) above.

Most often, the cathode of the cell operates with dioxygen. The dioxygen for example comes from a tank consisting of air, preferably enriched air, from a tank including pure dioxygen or ambient air. The dioxygen is conveyed, for example by means of a pipe or equivalent from the tank to the cathode. As such, the cathode is provided with an orifice by which the pipe or equivalent is secured.

According to an embodiment, the anode portion and the cathode portion preferably include a medium diffusing dihydrogen and dioxygen, as well as a catalyst.

The diffusing medium is generally an electron conductor and for example consists of woven carbon fibers in which porous graphite particles are included. The gas molecules pass in this case through the grid of woven fibers and the electrons are conveyed by the carbon fibers. According to another embodiment, it also consists of a cross-linked polymer pervious to gases such as PDMS (polydimethysiloxane) loaded with porous graphite particles.

The catalyst is often formed with a finely divided metal incorporated into the porous graphite particles. Platinum may be used, but as indicated earlier, it is desired to avoid this metal. Therefore, it possible to use for example nickel as a replacement.

Several methods may be used for stacking the active layers of a fuel cell. A first method consists of superposing the layers on each other, generally from the anode to the cathode in order to form a complete stack of a microcell. A second method consists of making the anode and the cathode separately, in order to then assemble them, for example under a press. Although different in their final assembling mode, both of these methods use similar techniques for depositing layers. For example it is possible to start with a gas diffusion layer (GDL) which for example corresponds to the hydrogenated silicon able to generate dihydrogen, and then deposit an anode collector (for example by cathode sputtering, evaporation or electrodeposition) and then deposit an anode catalyst for forming the anode portion. The anode catalyst may be deposited by sputtering (spray), ink jet or electrodeposition. Next, it is possible to deposit the anode membrane according to the present invention, for example by spraying (spray) or ink jet. It is then possible to deposit, for example also by spraying (spray) or ink jet the cathode catalyst, and then the cathode collector in order to form the cathode portion.

According to an alternative, the method of the invention successively comprises a preparation of virgin silicon wafers, a thermal oxidation of the latter at the surface, cathode sputtering of conductive metals on the oxidized surface, deposition of a photosensitive resin, photolithography of patterns through a mask, development of the insolated patterns, etching of the conductive metal layers, deoxidation of the surface intended to receive the anionic membrane, humid etching of the membranes, anodization of the membrane in order to obtain a porous silicon membrane, etching by plasma of the membrane on the rear face, hydroxylation of the surface of the membrane of porous silicon, thermal activation of the porous silicon membrane, grafting and growth by a sol-gel method of a silica gel comprising cationic groups.

According to another particularly advantageous alternative for limiting the mechanical stresses on the inorganic support, the method of the invention comprises grafting of a monolayer of silica gel comprising cationic groups by a sol-gel method, hydrolysis of the molecules of grafted silanes, and growth by a sol-gel method of the grafted silica gel. Advantageously, the method successively comprises a preparation of virgin silicon wafers, thermal oxidation of the latter at the surface, cathode sputtering of the conductive metals on the oxidized surface, deposition of a photosensitive resin, photolithography of patterns through a mask, development of insolated patterns, etching of conductive metal layers, deoxidation of the surface intended to receive the anionic membrane, humid etching of the membranes, anodization of the membrane in order to obtain a porous silicon membrane, etching by a plasma of the membrane on the rear face, grafting of a monolayer of silica gel comprising cationic groups by a sol-gel method, hydrolysis of the grafted silane molecules, and a growth with a sol-gel method of the grafted silica gel.

The obtained support is advantageously rinsed.

In order to ensure quality control of the product during its manufacturing, it is possible to conduct analyses by infrared spectrometry (FTIR) between certain manufacturing steps. More particularly, it is possible to carry out such a control before and/or after grafting and/or growth of the sol-gel.

Advantageously, the prepared supports are stored in water in the presence of a hydroxide ion exchanger resin.

According to an alternative, the grafting and/or the growth of the cationic silica gel is carried out by immersion of the membranes in a silane solution in a solvent.

In comparison with the device of the aforementioned patent applications, and notably application WO 2008/148988, the present invention notably has the advantage of regulating the dihydrogen flow rate notably by regulating the amount of water added depending on the electric current between the anode and the cathode. Moreover, the present invention has the advantage of using water as a reagent and no longer as a product of the reaction. Therefore it is no longer necessary to provide a water container in contact with the hydrogenated porous silicon. Further, the water contained in the ambient atmosphere (humidity of the air) may be used as a water source.

More particularly, the device of the invention, and more particularly the fuel cell, may be transportable or fixed.

Advantageously, the device may be biocompatible and comprise a membrane (10) comprising or consisting of an inorganic support as defined according to the invention.

In the invention, the use of the term of “one” means “at least one”.

Other objects, features and advantages of the invention will become clearly apparent to one skilled in the art following the reading of the explanatory description which refers to examples which are only given as an illustration and which by no means can limit the scope of the invention. Thus, each example has a general scope.

On the other hand, in the examples, all the percentages are given by mass, unless indicated otherwise, and the temperature is expressed in degree Celsius and is room temperature (20-25° C.), unless indicated otherwise, and the pressure is atmospheric pressure (101325 Pa), unless indicated otherwise.

### EXAMPLES

### Example 1

### Preparation of the Cationic Support According to the Invention

—Preparation of a Silicon Wafer

A virgin silicon wafer is prepared. The silicon used is of the N+, P-doped type with a resistivity p=0.012-0.014 Ω·cm, thickness 525+/−25 μm, polished on both faces.

—Thermal Oxidation

The silicon wafer is thermally oxidized in an oven at 1,000° C. under flow of oxygen and steam for a period of about 6 h 15 mins for oxidizing the silicon over a thickness from 1.2 to 1.4 μm.

—Cathode Sputtering

Cathode sputtering of chromium (Cr) and then of gold (Au) is then successively carried out on each of the faces of the wafer in a vacuum of less than or equal to 1.10⁻⁶ mbar. Apparatus used: Plassys MP 500.

Deposition Parameters Used:
Cleaning the substrate: 5 min at 150 W, working pressure 0.13 mbar;
Cleaning of the Cr target: 20 s at 0.5 A, working pressure 0.07 mbar;
Cr layer deposition: 20 s at 0.5 A (15 to 20 nm deposited), identical working pressure;
Au layer deposition: 2 min at 0.6 A (about 800 nm deposited), identical working pressure.

—Deposition of Photosensitive Resin

The photosensitive resin Microposit S 1813 is deposited on each face: Spinner parameters:
Preliminary deposition of 2 ml of an adhesion promoter for the resin on the substrate, HMDS (hexamethyldichlorosulfate):
speed of rotation=3,000 rpm⁻¹
acceleration=3,000 rpm⁻²
duration=30 s
Deposition of the resin (3 ml): identical spinner parameters.

Annealing parameters for the resin: 20 s on a heating hob at 120° C. and then 5 min at room temperature.

Photolithography of the patterns through a chromium-plated glass mask. The resin Microposit S 1813 is insolated with an energy of 60 mJ.

Development of the insolated patterns in the developer AZ 726 for about 30 s on each face of the water, with a stirrer (100 rpm), and then rinsing with deionized water and drying with nitrogen.

Etching of the Au layer at the location of the developed membranes, with a solution for etching gold based on iodine and iodide MICROPUR (Sotra-chem) for about 1 min with a stirrer (100 rpm), and then rinsing with deionized water and drying with nitrogen.

Etching of the Cr layer at the location of the developed membranes, with a suitable solution for etching Cr (Microposit Cr Etch 18) for about 20 s with a stirrer (100 rpm), and then rinsing with deionized water and drying with nitrogen.

Deoxidation at the location of the membranes with a solution of ammonium bifluoride (BHF, consisting of 7 vol. of NH₄F and 1 vol. of HF) and then rinsing with deionized water and drying with nitrogen.

Humid etching of the membranes in a potassium hydroxide solution (KOH, 10 mol·l⁻¹ at 55° C.). The thickness of the membranes is adjusted to 50 μm by timing the etching period (parameterized etching rate→an outsourced step). Rinsing with deionized water and drying with nitrogen.

Anodization in a bath consisting of hydrofluoric acid (48% in solution) and of pure ethanol in 1:1 proportions.

Current Densities Used:

For the Relevant N+ Type:
50 mA·cm⁻² for pore diameters of 10 nm
100 mA·cm⁻² for 20 nm pore diameters
250 mA·cm⁻² for 30 nm pore diameters

Short rinsing with deionized water, drying with nitrogen (operate at a low pressure).

—Plasma Etching (Reactive Ion Etching) of the Membranes on the Rear Face:
Apparatus used: Plassys MG 200

Standard Method:
20 sccm of SF₆,
7 sccm of O₂,
power: 75 W,
pressure: 100 μbars,
period: a minimum of 4 min.

—Geometry

The chip is a square for which the side is equal to 78 mm. The membrane is a square for which the side has the value 2.7 mm. Therefore the mask consists of squares with a side of 3 mm with a periodicity of 0.78 mm (see FIG. 2). The cutouts may be carried out along the lines of the final cutout (200).

—FTIR Control

It is checked that the porous silicon is mainly in the form of Si—H and that there does not remain any silicon on the rear face. The presence of a little oxide is not bothersome, since the next step will consist of oxidizing all the Si—H functions. However, it seems that in certain cases, the presence of O—SiH groups has resistance to UVO oxidation (UV ozone).

—Hydroxylation

UV ozone 28 mW/cm² for 30 minutes on each face (JELIGHT 42 UVO cleaner)

—FTIR Control

It is checked that the surface of the porous silicon includes Si—OH functions and that there no longer remain any Si—H functions or O—Si—H functions.

—Activation

The silicon is placed in an oven at 120° C. for 15 minutes.

—FTIR Control

It is checked that the surface of the porous silicon includes free Si—OH functions (thin band at 3,840 cm⁻¹).

—Sol-Gel Grafting

Immersion of the membranes in the 50% silane solution in methanol (CAS 35141-36-7)+1M KCl at pH 9.

Reaction for 9 hours at room temperature.

Rinsing then ovening at 120° C. for 15 minutes.

—FTIR Control

The concentration of quaternary ammonium groups is measured. A measurement made possible by prior calibration of the doublet at 1,480 cm⁻¹ carried out in a liquid cell with a measured fixed thickness.

—Storage

The membranes are immersed in water in the presence of ion exchange resins (type H⁺ and OH⁻) for removing the ions introduced by the potassium chloride and substituting the silane chloride ions with hydroxide ions.

### Example 2

### Preparation of the Cationic Support without Prior Oxidation of the Hydrogenated Silicon According to the Invention

—Preparation of a Silicon Wafer

A virgin silicon wafer with a diameter of 4 inches is prepared. The silicon used is of the N+ type doped with P, with a resistivity p=0.012-0.014 Ω·cm, thickness 525+/−25 μm, polished on the two faces.

—Thermal Oxidation

The silicon wafer is thermally oxidized in an oven at 1,000° C. under an oxygen and steam flow for a period of about 6 h 15 min for oxidizing the silicon over a thickness from 1.2 to 1.4 μm.

Duration of steam: 6 h 15 about for a thickness of 1.2 to 1.4 μm.

—Cathode Sputterings

Cathode sputtering of chromium (Cr) and then of gold (Au) is then carried out successively on each of the faces of the wafer in a vacuum ≦1.10-6 mbar. Apparatus used: Plassys MP 500.

Deposition Parameters Used:
Cleaning of the substrate: 5 min at 150 W, working pressure 0.13 mbar;
Cleaning of the Cr target: 20 s at 0.5 A, working pressure 0.07 mbar;
Deposition of the Cr layer: 20 s at 0.5 A (15 to 20 nm deposited), identical working pressure;
Deposition of the Au layer: 2 min at 0.6 A (about 800 nm deposited), identical working pressure.

—Deposition of the Photosensitive Resin

The photosensitive resin Microposit S 1813 is deposited on each face: Spinner parameters:
Preliminary deposition of 2 ml of a promoter for adherence of the resin on the substrate, HMDS (hexamethyldichlorosulfate):
speed of rotation=3,000 rpm⁻¹
acceleration=3,000 rpm⁻²
duration=30 s
Deposition of the resin (3 ml): identical spinner parameters.

Annealing parameters of the resin: 20 s on a heating hob at 120 CC and then 5 min at room temperature.

Photolithography of the patterns through a chromium-plated glass mask. The resin Microposit S 1813 is insulated with an energy of 60 mJ.

Development of the insolated patterns in the developer AZ 726 for about 30 s on each face of the wafer, with a stirrer (100 rpm), and then rinsing with deionized water and drying with nitrogen.

Etching of the Au layer at the location of the developed membranes, with a gold etching solution based on iodine and iodide MICROPUR (Sotra-chem) for about 1 min with a stirrer (100 rpm), and then rinsing with deionized water and drying with nitrogen.

Etching of the Cr layer at the location of the developed membranes, with a suitable Cr etching solution (Microposit Cr Etch 18) for about 20 s with a stirrer (100 rpm), and then rinsing with deionized water and drying with nitrogen.

Deoxidation at the location of the membranes with a solution of ammonium bifluoride (BHF, consisting of 7 Vol. of NH₄F and 1 Vol. of HF) and then rinsing with deionized water and drying with nitrogen.

Wet etching of the membranes in a potassium hydroxide solution (KOH, 10 mol·l⁻¹ at 55° C.). The thickness of the membranes is adjusted to 50 μm by timing the etching period (parameterized etching rate→out-sourced step). Rinsing with deionized water and drying with nitrogen.

Anodization in a bath consisting of hydrofluoric acid (in a solution at 48%) and of pure ethanol in 1:1 proportions.

Current Densities Used:

For the Relevant N+ Type:
50 mA·cm⁻² for pore diameters of 10 nm
100 mA·cm⁻² for pore diameters of 20 nm
250 mA·cm⁻² for pore diameters of 30 nm

Short rinsing with deionized water. Drying with nitrogen (operate at low pressure).

Plasma etching (Reactive Ion Etching) of the membranes on the rear face:
Apparatus used: Plassys MG 200

Standard Method:
20 sccm of SF₆,
7 sccm of O₂,
power: 75 W,
pressure: 100 μbars,
duration: a minimum of 4 min.

—Geometry

The chip is a square for which the side is equal to 78 mm. The membrane is a square for which the side has the value of 2.7 mm. Therefore the mask is made with squares of 3 mm with a periodicity of 0.78 mm (see FIG. 2). The cutouts may be carried out along the final cutting-out lines (200).

—FTIR Control

It is checked that the porous silicon is in the Si—H form and that there no longer remains any silicon on the rear face. If an onset of oxidation is detected (SiO₂ or O—SiH) the membrane is again immersed in a HF 50% mixture with 1:1 ethanol for 10 minutes.

—Monolayer Grafting

Immersion of the membranes in a diluted solution of silane in methanol (less than 0.014% of water) at a concentration of the order of 5% (CAS 35141-36-7) for 10 h. Nitrogen bubbling U (less than 5 cm³ of water/m³) is continuously maintained during the whole period of the grafting.

—FTIR Control

The presence of quaternary ammonium group is controlled (characteristic bands of N—CH₃ and NC—H₃. It is checked that the grafted silane molecules still include non-hydrolyzed methoxy functions. A very strong reduction in the characteristic bands of the Si—H functions is ascertained.

—Hydrolysis of the Grafted Silane Molecules

Immersion of the membranes in a hydrochloric acid solution diluted to pH 4 for a few hours.

—FTIR Control

The stability of the quaternary ammonium group is controlled, it is checked that the grafted silane molecules are now totally hydrolyzed.

—Sol-Gel Growth

Immersion of the membranes in a silane solution in 10% methanol (CAS 35141-36-7) at pH 4. 9 hour reaction at room temperature. Rinsing and then ovening at 120° C. for 15 minutes.

—FTIR Control

The concentration of quaternary ammonium groups is measured. This measurement is made possible by prior calibration of the doublet at 1,480 cm⁻¹ carried out in a liquid cell with a measured fixed thickness.

—Storage

The membranes are immersed in water in the presence of ion exchange resins (of the OH⁻ type) for replacing the chloride ions of the silane with hydroxide ions.

The silane used in examples 1 and 2 is N-trimethoxysilylpropyl-N,N,N-trimethylammonium chloride.

### Example 3

### Characterization of the Cationic Support According to the Invention

### Example 3.1

### Concentration of the Cationic Groups

It is possible to quantify by infrared spectroscopy the active molecules (quaternary ammonium groups) obtained after calibration of the characteristic doublet of this group around 1,480 cm⁻¹. It is possible to quantify the concentration of active molecules in the membrane. Depending on the conditions of example 1, the obtained concentrations are of the order of 3 mol/l, thereby giving the possibility of obtaining good anionic conduction. Taking into account of the porosity equal to 50% of the membranes, the effective concentration of active material in the pores is therefore 6 mol/l.

### Example 3.2

### Conductivity

The conductivity may be characterized by impedance spectroscopy. A thin gold layer is deposited on each surface of a sample obtained according to example 1, and the anionic conduction is then measured by impedance spectroscopy in an atmosphere with controlled humidity (RH=97%) at room temperature (20° C.). A conductivity of 20 mS/cm is typically obtained, which is quite interesting for anionic membrane applications, notably for fuel cells.

### Example 3.3

### Stability in an Alkaline Medium

The following tests gave the possibility of characterizing the stability in an alkaline medium:

When a membrane of hydrogenated porous silicon is put into contact with an alkaline solution, dihydrogen bubbles rapidly appear expressing the reaction III.

A hydroxylated porous silicon membrane is immersed, after measuring the infrared spectrum in an ammonia solution at pH 11 for 100 h and then rinsed.

No gas bubble appears. In order to specify this stability, this infrared spectrum is utilized which allows measurement of the optical path n.e (n refractive index, e thickness) by the interferences from reflections on both faces of the membrane. No variation in the optical path is observed.

The membrane is stable in an alkaline medium.

### Example 3.4

### Influence of the Silica Gel Concentration in the Pores

The following experiments gave the possibility of quantifying the influence of the concentration of the cationic silica gel in the pores on certain properties of the cationic support of the invention: Several membranes are made by using silane solutions of different concentrations and different grafting times. At the end of the grafting, the concentration of quaternary ammonium group is measured and then after depositing a thin gold layer on each face of these membranes, the ion conductivity is measured by impedance spectroscopy. The results are summarized in the following table 1:

TABLE 1

| Grafted [quaternary ammonium] | Conductivity |
|---|---|
| mol/l | mS/cm |
| 0.5 | 9 |
| 1.3 | 14 |
| 2.9 | 20 |

A priori, the gel occupies the whole of the volume which is available to it.

### Example 4

### Preparation of a Fuel Cell

An exemplary embodiment is illustrated by FIG. 1.

The fuel cell consist of a stack of three silicon wafers (a, b, c) with dimensions 7 mm×7 mm×0.5 mm stuck to each other. The central wafer (a) bears the anionic membrane (10) with a thickness of 50 μm occupying a surface of 10 mm² at the center of the wafer (a). It is made by grafting a silane gel bearing quaternary ammonium functions on the surface of the pores a mesoporous silicon membrane. It ensures the conductivity of the hydroxide of ions during the operation of the cell.

On the surface of each face of the membrane (10) is deposited by spraying or by an ink jet, or by depositing quite simply drops of an anionic catalytic ink consisting of a 10:1 mixture of porous graphite powder bearing platinum and an anionic conductor (silane used for making the membrane) in solution in a water-methanol mixture. The lower wafer (b) consists of hydrogenated porous silicon (20). Its role is to generate dihydrogen by action of the water produced by the operation of the cell.

The upper wafer (c) consisting of macroporous silicon (30), pervious to the oxygen contains the water reserve. It may be made in macroporous silicon impregnated with water for example and pierced with orifice for letting through oxygen. It is also possible to use the humidity of the ambient oxygen if it is sufficient towards the required current flow rate. A film impervious to carbon dioxide (50) (PTFE for example) isolates the cell from any external contamination.

The electric contacts are taken at the junction of the wafers by using an electrically conductive adhesive.

The cathode (35) is located in contact with the macroporous silicon (30) comprising the reserve of water. The anode (25) is located in contact with the hydrogenated porous silicon (20).

1. A cationic support wherein said cationic support comprises a solid inorganic support comprising pores, said pores being at least at a surface of said solid inorganic support, wherein a silica gel comprising cationic groups, designated here as “cationic silica gel” or “cationic silica sol” is covalently bound to said inorganic support.

2. The cationic support according to claim 1, wherein said solid inorganic support comprising pores is a porous silicon, a porous silicon carbide, a porous alumina or a porous glass.

3. The cationic support according to claim 1, wherein said cationic groups are quaternary ammonium groups.

4. The cationic support according to claim 1, wherein said cationic groups are bound to the silica gel through at least one linear or branched saturated alkyl group, optionally substituted.

5. The cationic support according to claim 1, wherein said pores are filled in totality or are partly filled with the cationic silica gel.

6. An anionic membrane comprising a cationic support as defined according to claim 1.

7. A method for preparing a cationic support according to claim 1, wherein said method comprises a coupling reaction by a covalent bond (or grafting) between the surface of pores of a porous solid inorganic support, made reactive beforehand, and a silane or a silane mixture comprising at least one cationic group and at least one reactive group with the reactive surface of the inorganic support, and obtaining of said solid inorganic support, the pores of which comprise at least at the surface a silica gel comprising cationic groups, designated here as “cationic silica gel” or “cationic silica sol”.

8. The method according to claim 7, wherein the silane is an N-dialkoxysilylalkyl or N-trialkoxysilylalkyl-N,N,N-tri-alkoxyammonium of formula (I): 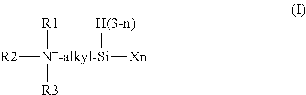
wherein n represents 1, 2 or 3, “alkyl” is a linear or branched saturated alkyl group optionally substituted, R1, R2 and R3 are substituents of the nitrogen atom, either identical or different, and X is a reactive group with a Si—OH group.

9. The method according to claim 7, wherein that the support is a porous silicon, and wherein said method comprises oxidation of the porous silicon at the surface of the pores in order to obtain a Si—O—Si function, and hydroxylation of the silica obtained at the surface of the pores for obtaining Si—OH functions, prior to the coupling reaction.

10. The method according to claim 7, wherein the support is a porous silicon, and wherein the coupling between the surface of the pores of the porous solid inorganic support and the silane or silane mixture is achieved by reaction between the surface of pores of the porous solid inorganic support including Si—H functions and a silane bearing one or several alkoxy groups.

11. The method according to claim 7, wherein the coupling reaction is achieved according to a sol-gel method.

12. A fuel cell comprising a membrane that comprises a cationic support, wherein said cationic support comprises a solid inorganic support comprising pores, said pores being at least at a surface of the solid inorganic support, wherein a silica gel comprising cationic groups, designated here as “cationic silica gel” or “cationic silica sol”, is covalently bound to said inorganic support.

13. A biocompatible device comprising a membrane comprising or consisting of a cationic support, wherein said cationic support comprises a solid inorganic support comprising pores, said pores being at least at a surface of the solid inorganic support, wherein a silica gel comprising cationic groups, designated here as “cationic silica gel” or “cationic silica sol”, is covalently bound to said inorganic support.

14. The method according to claim 7, wherein the support is a porous silicon, and wherein the coupling between the surface of the pores of the porous solid inorganic support and the silane or silane mixture is achieved by reaction between the surface of pores of the porous solid inorganic support including Si—H functions and a silane bearing one or several methoxy groups.
